(19) United States
(12) Patent Application Publication
(10) Pub. No.: US 2009/0295776 A1
(43) Pub. Date: Dec. 3, 2009

(54) Light emitting diode driving circuit and controller thereof

(76) Inventors: Chung-Che Yu, Yonghe City (TW); Chen-Hsung Wang, Sinjhuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,189

(22) Filed: Sep. 30, 2008

(30) Foreign Application Priority Data
May 30, 2008 (TW) 97120287

(51) Int. Cl. G06F 3/038

(52) U.S. Cl. 345/212

(57) ABSTRACT

A light emitting diode driving circuit comprising: a current control unit, a current detection unit, and a driving control unit. The current control unit connects to the current detection unit and comprises a control end, a first input/output end, and a second input/output end to individually produce an electric potential detection signal. The light emitting diode driving circuit determines whether driving the light emitting diode is unusual or not according to the electric potential detection signals to decide to start a protect mechanism. Furthermore, the present invention can receive any types of dimming signals to adjust the light of the light emitting diode.

### BACKGROUND OF THE INVENTION

1. Field of the Invention

The present invention relates to a light emitting diode driving circuit and a controller thereof, and more particularly to a light emitting diode driving circuit and a controller thereof with dimming function and abnormality response.

2. Description of Related Art

Compared with the widely used fluorescent lamps, light emitting diode (LED) has the advantages of long lifetime, economical power consumption, low driving voltage, high security, environmental protection oriented, and etc. As to the liquid crystal display (LCD) industry, because LED as a light source of the backlight module has color saturation much higher than that of the present main-stream cold cathode fluorescent lamp (CCFL) and is completely conformed to the regulations of restriction of hazardous substance (ROHS). Therefore, the industry has devoted lots of efforts in research and development for expecting to use LED to take over the market of the other types of lighting sources.

FIG. 1 shows a circuit diagram of a typical current balancing LED driving circuit. As shown, an alternative current (AC) input from an input power source AC is first converted into a direct current (DC) voltage VDD through an AC-to-DC converter 30. Subsequently, the DC voltage VDD is converted into a driving voltage Vin through a DC-to-DC converter 40, and the driving voltage Vin is then provided to the LED driving circuit. The AC-to-DC converter 30 has a bridge rectifier (not shown) for converting the AC input into the DC voltage VDD. Voltage level of the DC voltage VDD is then reduced to generate the driving voltage Vin by using a switched-mode power converting circuit (not shown) inside the DC-to-DC converter 40. The LED driving circuit has a LED module 10 and a current balancer 20. The LED module 10 is composed of a plurality of LEDs connected in parallel and in series. In order to have brightness of the LEDs of different LED strings being consistent, current flowing through each of the LED strings must be identical by using the current balancer 20. The current balancer 20 equalizes current on the different LED strings by using the architecture of current mirror. The magnitude of current flowing through each of the LEDs can be controlled by the resistor R.

The magnitude of current flowing through the LED can be represented by the function:

I=(VDD−VG)/R,

where VG is the gate voltage of the semiconductor switch in the current balancer 20.

However, conventional current balancing LED driving circuit lacks an adequate protection mechanism. If any abnormality occurs in the circuit, such as short circuit, open circuit, operating range exceeded etc., unnecessary power loss or even circuit damage would be resulted because the current balancing LED driving circuit is operating. Besides, typical current balancing LED driving circuit does not have dimming function. It is hard to satisfy the requirements of some specific applications (e.g. back-light module). The application of the current balancing LED driving circuit is thus limited.

### SUMMARY OF THE INVENTION

In view of the above-discussed issues, the present invention discloses an LED driving circuit with dimming function and abnormality response. The LED driving circuit may determine if any error occurs when driving the LED based on the detection signal of the LED and is capable to activate the protection mechanism to stop the operation of the driving circuit or provide warning signals. In addition, the LED driving circuit is capable to control brightness of the LED based on any mode of dimming signals.

To achieve the aforementioned advantages, an LED driving circuit comprising a conversion circuit, at least one current control unit, at least one current detection unit, and a driving control unit is provided in the present invention. The conversion circuit is coupled to an input power source for converting an input power from the input power source into a DC output signal to drive an LED module. Each of the current control units has a control pin, a first input/output (I/O) pin and a second I/O pin, and the first I/O pin is coupled to the LED module. Each of the current detecting modules is coupled to the second I/O pin of the respective current control unit to generate at least one detection signal. The driving control unit is coupled to the control pin and the first I/O pin of the current control unit, and also coupled to the current detection unit. The driving control unit is capable to adjust voltage level (i.e. high or low) of the control pin of the current control unit based on the detection signal so as to have the current flowing through the LED module stabilized around a preset current value. In case voltage level of one of the first I/O pins being higher than a preset level, the driving control unit cuts off the respective current control unit.

The present invention provides another LED driving circuit, which comprises a conversion circuit, at least one current control unit, at least one current detection unit, and a driving control unit. The conversion circuit is coupled to an input power source in order to convert an input power from the input power source into a DC output signal to drive an LED module. Each of the current control units has a control pin, a first I/O pin, and a second I/O pin, wherein the first I/O pin is coupled to the LED module. Each of the current detection units is coupled to the second I/O pin of the respective current control unit to generate at least one detection signal. The driving control unit is coupled to the control pin and the first I/O pin of the current control unit, and also coupled to the current detection unit. The driving control unit is capable to adjust voltage level of the control pin of the respective current control unit based on the detection signal so as to have current flowing through the LED module stabilized around a preset current value. The above-mentioned driving control unit is capable to generate a fault signal as voltage level of one of the first I/O pins is higher than a first preset level.

The present invention also provides an LED driving circuit controller to control an LED driving circuit for driving an LED module. The LED driving circuit controller comprises a current adjusting unit and a signal processing unit. The current adjusting unit generates a current adjusting signal based on a current detection signal, which indicates magnitude of current flowing through the LED module, for controlling a power switch connected in series to the LED module to have voltage level of the current detection signal stabilized around a preset voltage value. The signal processing unit detects voltage level of the voltage signal from a coupling point between the power switch and the LED module, receives the current detection signal, and generates a fault signal when voltage level of the current detection signal lower than a first preset level over a preset period of time or voltage level of the voltage signal from the coupling point being higher than a second preset level.

The Summary set out supra and the Detailed Descriptions discussed infra are for illustrative purposes only in order to further construe the scope of the present invention. Other objectives and advantages related to the present invention will be thoroughly explained in the subsequent descriptions and drawings.

### BRIEF DESCRIPTION OF THE DRAWINGS

FIG. 1 is a circuit diagram of a typical current balancing LED driving circuit;

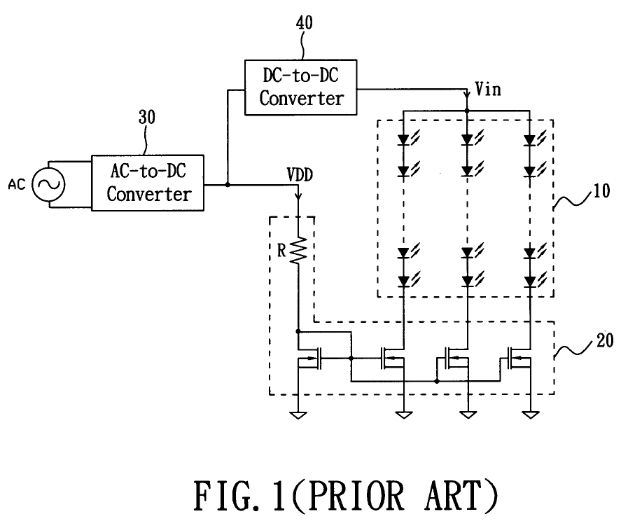

FIG. 2 is a circuit diagram of an LED driving circuit of a preferred embodiment according to the present invention;

FIG. 3 is a circuit diagram of a driving control unit of an embodiment according to the present invention;

FIG. 4 is a circuit diagram of a driving control unit of another embodiment according to the present invention;

FIG. 5 is a circuit diagram of a driving control unit of yet another embodiment according to the present invention; and

FIG. 6 is a circuit diagram of an LED driving circuit of another embodiment according to the present invention.

### DETAILED DESCRIPTION OF PREFERRED EMBODIMENTS

In present, the available Light Emitting Diode (LED) driving circuit with fixed voltage level to drive LED does not have dimming function and protection mechanism. The LED driving circuit according to the present invention not only provides protection mechanism against circuit abnormality but also performs dimming function based on a dimming signal. In addition, the LED driving circuit according to the present invention may achieve the feature of synchronous dimming on multiple LED groups by means of outputting dimming Pulse-Width-Modulation (PWM) signals. The technology of the present invention will be illustrated by the embodiments as follow.

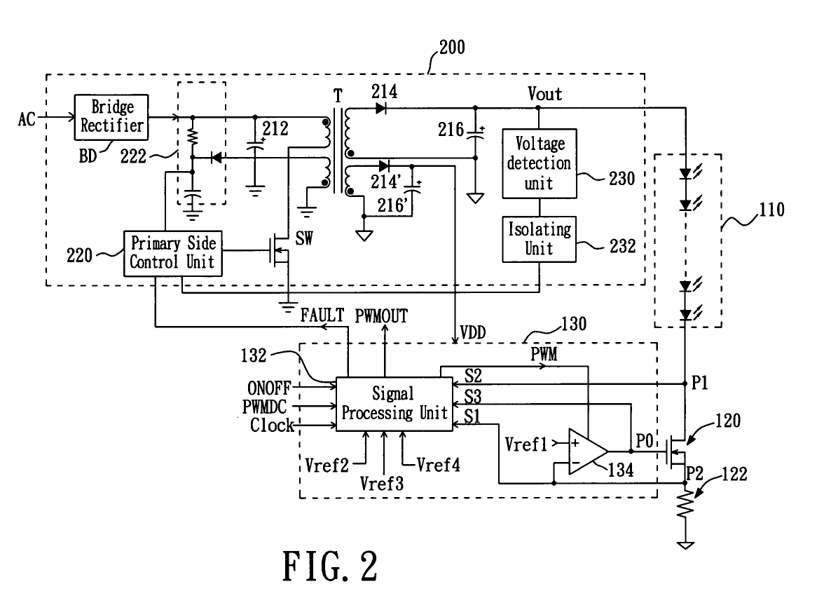

Refer to FIG. 2, a circuit diagram of an LED driving circuit of a preferred embodiment according to the present invention is shown. The LED driving circuit comprises a conversion circuit 200, a current control unit 120, a current detection unit 122, and a driving control unit 130. The conversion circuit 200 is coupled to an input power source AC in order to convert an input power from the input power source AC into a DC output signal Vout to drive an LED module 110. The current control unit 120 has a semiconductor switch. In addition, the current control unit 120 has a control pin P0, a first I/O pin P1, and a second I/O pin P2. The first I/O pin P1 of the current control unit 120 is coupled to the LED module 110 so that the current control unit 120 is connected to the LED module 110 in serial. The current detection unit 122 may be a resistor coupled to the second I/O pin P2 of the current control unit 120 to generate a current detection signal S1 based on the magnitude of the current flowing through the LED module 110. The driving control unit 130 is coupled to the control pin P0 and the first I/O pint P1 of the current control unit 120, and also coupled to the current detection unit 122. The driving control unit 130 may adjust voltage level at the control pin P0 of the current control unit 120 based on the detection signal S1 so as to change the magnitude of equivalent resistance of the current control unit 120 to have the current flowing through the LED module 110 stabilized around a preset current value.

The above mentioned conversion circuit 200 can be a flyback power converter, a forward power converter, a pull-push power converter, a half-bridge power converter, a full-bridge power converter, or a DC-to-DC converter. In the present embodiment, a flyback power converter is shown as an example to illustrate the present invention. As shown, the flyback power converter comprises a transformer T, a switch set SW (in the flyback power converter, the switch set SW has one semiconductor switch, while in other types of power converters, such as half-bridge type and full-bridge type, the switch set may have a plurality of semiconductor switches), an output capacitor 216, a voltage detection unit 230, and a primary side control unit 220. The transformer T has a primary side and a secondary side, wherein the primary side is coupled to the input power source AC via a bridge rectifier BD, the secondary side generates the DC output signal Vout through a rectifying unit 214. The switch set SW is coupled to the primary side of the transformer T and is switched between conducting state and off state based on a control signal from the primary side control unit 220. The output capacitor 216 is coupled to the secondary side of the transformer T for filtering out the noise from the DC output signal Vout so as to stabilize the voltage level of the DC output signal Vout. The voltage detection unit 230 is coupled to the secondary side of the transformer T for detecting the voltage level of the DC output signal Vout to generate a voltage detection signal. The voltage detection signal is then transferred to the primary side control unit 220 through an isolation unit 232, which is capable to effectively isolate the primary side from the secondary side of the transformer T. The primary side control unit 220 identifies whether the DC output signal Vout is excessively high or over low based on the feedback voltage detection signal so as to adjust pulse width of the control signal to control the switch set SW, such that the DC output signal Vout can be stabilized around the preset voltage value.

The primary side of the above-mentioned transformer T may have an input capacitor 212, an initial driving circuit 222, and a primary side auxiliary coil. The input capacitor 212 is used to stabilize the voltage level of a DC input voltage from the bridge rectifier BD. The initial driving circuit 222 has a resistor, a capacitor, and a diode. As the input power source AC is connected to the bridge rectifier BD, the capacitor begins to be charged via the resistor. When the voltage level in the capacitor reaches an enable level, the primary side control unit 220 starts to operate and control the switching of the switch set SW. Then, the primary side auxiliary coil charges the capacitor of the initial driving circuit 222 through the diode of the initial driving circuit 222 with the energy stored in the transformer T. Since the coil ratio between the primary side auxiliary coil and the secondary side coil is given, while the DC output signal Vout is stabilized around the preset voltage value, the voltage in the capacitor of the initial driving circuit 222 would be also stabilized around a fixed voltage value. In addition, the secondary side of the transformer T may have a secondary side auxiliary coil as well. For the same reason, since the coil ratio between the secondary side auxiliary coil and secondary side coil is also given, the voltage level charged to an auxiliary output capacitor 216′ via an auxiliary rectifying unit 214′ would be also stabilized around a fixed voltage value so as to provide a driving voltage VDD to drive the driving control unit 130.

The driving control unit 130 has a signal processing unit 132 and a current adjusting unit 134. Because current flowing through the LED module 110 will flow through the current detection unit 122 also, the current detection unit 122 is capable to generate the current detection signal S1 for indicating the magnitude of the current flowing through the LED module 110. The current adjusting unit 134 may be an error amplifier, which adjusts the output current adjusting signal by comparing the current detection signal S1 with a first preset level Vref1 to adjust the voltage level of the control pin of the current control unit 120 (i.e. the gate voltage of the semiconductor switch in the current control unit 120). In this way, equivalent resistance of the semiconductor switch can be adjusted to have the voltage level of the current detection signal S1 stabilized around the first preset level Vref1, that is, the current flowing through the LED module 110 can be stabilized at a preset current value. The signal processing unit 132 receives the current detection signal S1, a control pin voltage signal S3 of the current control unit 120, a coupling point voltage signal S2 (the voltage signal of the first I/O pin P1 of the current control unit 120), a second preset level Vref2, a third preset level Vref3, a fourth preset level Vref4, an on/off signal ONOFF, a DC dimming signal PWMDC, and a clock signal CLOCK. The signal processing unit 132 determines whether any abnormality occurs in the LED driving circuit based on the above-mentioned signals, and if any abnormality has occurred, the signal processing unit 132 generates a fault signal FAULT. The fault signal FAULT may be transferred to the primary side control unit 220 as shown in FIG. 2 for the primary side control unit 220 to decide whether to stop the operation of the LED driving circuit or not. In addition, the fault signal FAULT may be output to a microprocessor of the system, e.g. the image microprocessor of a liquid crystal display, for the microprocessor to determine the suitable process to be taken; or notify the user through an user interface component, e.g. a fault indicator, and let the user to decide whether to stop the operation of the LED driving circuit or not. The detailed operations of the driving control unit 130 and the internal circuit thereof are described below.

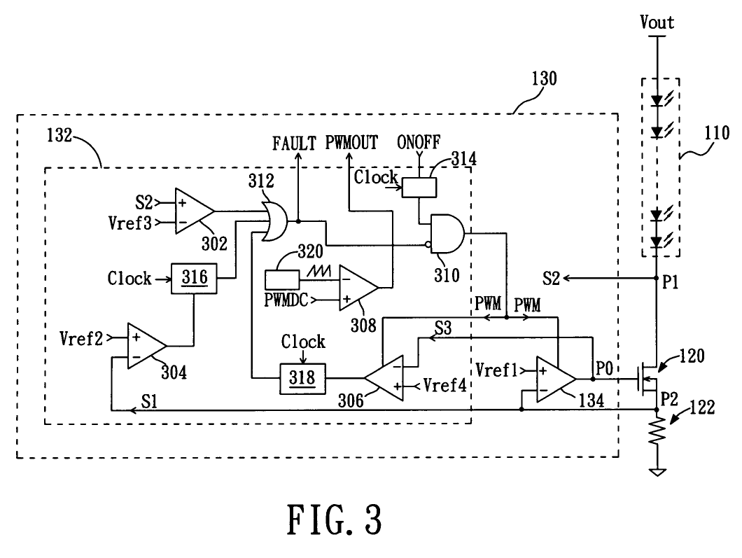

Refer now to FIG. 3, a circuit diagram of a driving control unit of an embodiment according to the present invention is shown. The driving control unit 130 comprises a signal processing unit 132 and a current adjusting unit 134. The signal processing unit 132 has four comparators 302, 304, 306, and 308, an AND gate 310, an OR gate 312, three time filtering units 314, 316, and 318, and a ramp signal generator 320. The current adjusting unit 134 may be an error amplifier comparing the current detection signal S1 and the first preset level Vref1. When the current detection signal S1 is lower than the first preset level Vref1, the current adjusting unit 134 increases the voltage level of the output current adjusting signal, i.e. the gate voltage of the semiconductor switch in the current control unit 120, so as to reduce the equivalent resistance of the semiconductor switch. The magnitude of the current flowing through the LED module 110 as well as the voltage level of the current detection signal S1 is thus increased. On the other hand, when the current detection signal S1 is higher than the first preset level Vref1, the current adjusting unit 134 reduces the voltage level of the output current adjusting signal to increase the equivalent resistance of the semiconductor switch. The magnitude of the current flowing through the LED module 110 as well as the voltage level of the current detection signal S1 is thus decreased. By means of the aforementioned feedback control mechanism, it is possible to stabilize the current flowing through the LED module 110 around a preset current value.

The comparator 304 in the signal processing unit 132 compares the current detection signal S1 and the second preset level Vref2. The second preset level Vref2 is lower than the first preset level Vref1. Under normal condition, the current detection signal S1 is equal to the first preset level Vref1, and the comparator 304 outputs a low-level signal. Whereas, under abnormal conditions, such as open circuit in the LED driving circuit, the current passing through the LED module 110 cannot be adjusted to the preset current value. At this moment, the current detection signal S1 would be lower than the second preset level Vref2, and the comparator 304 outputs a high-level signal indicating the circuit abnormality. Since the conduction of the LED driving circuit would be wrongly judged by the comparator 304 when the LED driving circuit is starting-up or during the dimming process, the signal processing unit 132 according to the present invention adopts a time filtering unit 316 and uses a clock signal CLOCK to determine whether the abnormal condition lasting over a preset period of time. If so, a signal which indicating the abnormality is sent to the OR gate 312. In the present embodiment, the clock signal CLOCK is externally provided. However, in practice, the clock signal may be generated internally by the driving control unit 130.

The comparator 302 in the signal processing unit 132 compares the third preset level Vref3 with the coupling point voltage signal S2, i.e. the voltage signal of the first I/O pin P1 of the current control unit 120. Under normal operating condition, the coupling point voltage signal S2 falls in a Safe Operating Area (SOA) such that the coupling point voltage signal S2 is lower than the third preset level Vref3. The consideration concerning the setting of the third preset level Vref3 is to build a limitation for preventing the coupling point voltage signal S2 from exceeding the tolerable voltage level of the current control unit 120 or resulting undesirable reduction in conversion efficiency. The third preset level Vref3 can be generated inside the driving control unit 130 or externally supplied. For example, as the current control unit 120 is designed to withstand 30-volt voltage, the third preset level Vref3 can be set at 25 volts, or as the DC output signal Vout is set at 30 volts, the third preset level Vref3 can be set at 6 volts under the consideration of conversion efficiency over 80%. In case a short circuit happened in the LED module 110, for example, an LED in the LED module 110 is fail, results in the reduction of voltage drop across the LED module 110, the potential of the coupling point voltage signal S2 is increased to exceed the third preset level Vref3. Then, the comparator 302 outputs a high-level signal representing the abnormal condition to the OR gate 312. It is noted that there may be two or more reference levels set in the comparison of the coupling point voltage signal S2 under different circumstances, such as the voltage level of 6 volts and 25 volts in the above-mentioned example.

The signal processing unit 306 in the signal processing unit 132 compares the fourth preset level Vref4 with the control pin voltage signal S3 of the current control unit 120 when the on/off signal ONOFF is high (which indicates the conducting state). The on/off signal ONOFF may be an enable signal or a burst dimming signal. In addition, the enable signal and the burst dimming signal may be input to the same pin of the signal processing unit 132, and judged by a time filtering unit 314. That is, if the on/off signal ONOFF is maintained at the same level over a predetermined period of time, the on/off signal ONOFF is judged as the enable signal, otherwise the on/off signal ONOFF should be the burst dimming signal. When the on/off signal ONOFF is low (which indicates the off state), the current adjusting unit 134 may cut off the current control unit 120. When the on/off signal ONOFF is high to indicate the conducting state, the current adjusting unit 134 resumes its operation to control the current control unit 120 to have the current flowing through the LED module 110 stabilized around a preset current value. Thereby, the LED driving circuit in accordance with the present invention can provide dimming function. The detailed operation of the comparator 306 is mentioned below.

Under normal operating condition, the semiconductor switch of the current control unit 120 operates in the linear region, therefore the equivalent resistance of the current control unit 120 can be adjusted by the potential of the control pin P0. However, when the on/off signal ONOFF is low to indicate the off state, the current adjusting signal provided by the current adjusting unit 134 would be low to cut off the current control unit 120. At this time, the control pin voltage signal S3 would be wrongly determined. To prevent this problem, the comparator 306 stops operating when the on/off signal ONOFF is low, and detects the voltage level of the current adjusting signal when the on/off signal ONOFF is not low. In addition, in case the current control unit 120 is damaged to result in short circuit, the control pin voltage signal S3 cannot be used to control the magnitude of the current flowing through the LED module 110. At this time, voltage level of the control pin voltage signal S3 of the current control unit 120 would be lower than the fourth preset level Vref4. Then, the comparator 306 would output a high-level signal indicating the abnormal condition. To avoid any possible wrong determination made by the comparator 306 during the transition of the on/off signal ONOFF, the time filtering unit 318 is employed.

When the OR gate 312 receives the signal indicating abnormality from any one of the comparators 302, 304 and 306, a fault signal FAULT is generated to indicate the occurrence of abnormal circuit operation. Furthermore, when the abnormality occurs and a fault signal FAULT is generated, the AND gate 310 may shutdown the driving control unit 130 based on the received the fault signal FAULT, as shown in FIG. 3, or the fault signal FAULT is merely used to notify microprocessors in the system or the user as described above. Certainly, in practical, other adequate processes after the fault signal FAULT has been generated can be performed based on the conditions of abnormality.

In addition to the above-mentioned burst dimming signal, the dimming signal may be a DC dimming signal too. As shown in FIG. 3, when a DC dimming signal PWMDC is provided, the comparator 308 compares the DC dimming signal PWMDC with a ramp signal generated by the ramp signal generated 320 to output a pulse-width-modulation signal PWMOUT. The pulse-width-modulation signal PWMOUT can be output to a driving control unit of another LED driving circuits as the on/off signal ONOFF to achieve the purpose of synchronous dimming. Whereas, if no such requirement, the pulse-width-modulation signal PWMOUT can be received by the original driving control unit 130 as the on/off signal ONOFF to periodically cut off the current control unit 120 to achieve the dimming function. In practice, the output end for outputting the pulse-width-modulation signal PWMOUT and the input end for inputting the on/off signal ONOFF of the driving control unit 130 can be packaged as two different pins. When the dimming signal is a DC dimming signal and no synchronous requirement, it may simply connect these two pins.

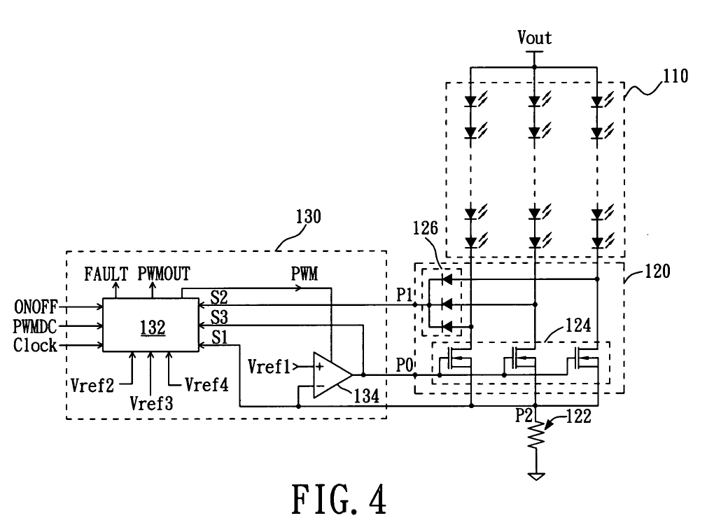

Refer now to FIG. 4, a circuit diagram of a driving control unit of another embodiment according to the present invention is shown. Comparing the embodiment depicted in FIG. 4 with the embodiment in FIG. 3, the major difference there between lies in the current control unit 120. The current control unit 120 in FIG. 4 comprises a current mirror unit 124 and a selection unit 126. The current mirror unit 124 consists of a plurality of semiconductor switches, and each semiconductor switch has a control end, a first I/O end and a second I/O end. The control ends of these semiconductor switches are coupled to each other to form the control pin P0 of the current control unit 120. The first I/O ends of these semiconductor switches are coupled to the LED module 110. The second I/O ends of these semiconductor switches are coupled to the current detection unit 122 to form the second I/O pin P2 of the current control unit 120. The selection unit 126 is coupled to the first I/O ends of these semiconductor switches of the current mirror unit 124 and selectively outputs one of the voltage level signals on these first I/O ends as the coupling point voltage signal S2 to the driving control unit 130. The selecting unit 126 may comprise a plurality of diodes. Positive ends of these diodes are coupled to the respective first I/O ends of the semiconductor switches in the current mirror unit 124, while negative ends of these diodes are coupled with each other to form the first I/O pin P1 of the current control unit 120. In this way, the selection unit 126 may output the voltage level signal with highest potential among the first I/O ends of these semiconductor switches. That is, when abnormality occurs to cause voltage level of first I/O end of a certain semiconductor switch abnormally rising, the driving control unit 130 may determine the abnormality and output the fault signal FAULT. Thereby, the driving control unit according to the present invention can drive the LED module with multiple LED series.

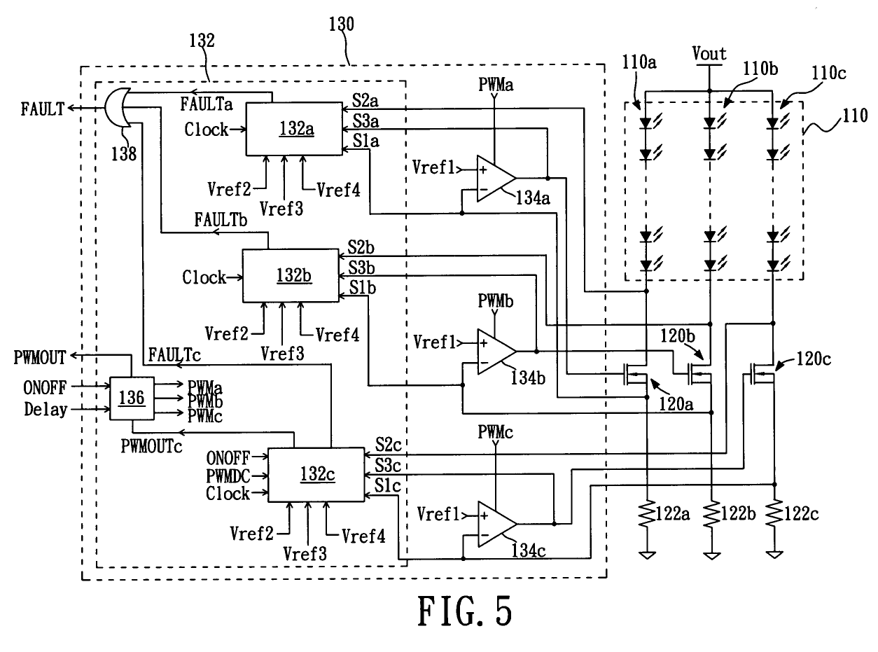

Refer now to FIG. 5, a circuit diagram of a driving control unit of yet another embodiment according to the present invention is shown. Compared with the embodiment in FIG. 4, the signal processing unit 132 of the driving control unit 130 in FIG. 5 is composed of a plurality of signal processors 132a, 132b, 132c operating individually. In FIG. 5, the components having the identical function in compared with that in the embodiment shown in FIG. 3 are given the same reference number and added label a, b, c for grouping the components. Since the operations of the components in each group follow the description of FIG. 3, only the operations concerning the relationship between these groups are illustrated. In the present embodiment, in order to avoid simultaneous switching of the semiconductor switches 120a, 120b, 120c to cause greater voltage ripple, a phase splitter 136 is used to generate pulse-width-modulation signals PWMa, PWMb, PWMc based on the delay signal Delay to control the current adjusting units 134a, 134b, 134c, respectively, such that there exists a time interval between the switching time of these semiconductor switches 120a, 120b, 120c. The delay signal Delay may be an external signal or generated inside the driving control unit 130. When any one of the signal processors 132a, 132b, 132c determines that abnormality occurs in the corresponding LED driving circuit, such as any one of the control pins of the semiconductor switches 120a, 120b, 120c is lower than the fourth preset level Vref4; any one of the second I/O pins is persistently lower than a second preset level Vref2 over a preset period of time; or voltage level on any one of the first I/O pins is higher than a third preset level Vref3, the driving control unit 130 may cut off the semiconductor switch 120a, 120b, 120c of the corresponded current control unit to shut down the operations of the abnormal LED driving circuit or cut off all the semiconductor switches 120a, 120b, 120c of the current control units. In addition, the driving control unit 130 may further send a fault signal FAULT through the OR gate 138. The on/off signal ONOFF received by the phase dividing unit 136 may be a burst dimming signal or a DC dimming signal PWMDC. When the DC dimming signal PWMDC is provided, the DC dimming signal PWMDC can be converted into the burst dimming signal by any one of the signal processors 132a, 132b, 132c, e.g. the signal processor 132c shown in FIG. 5. The phase splitter 136 also outputs a pulse-width-modulation signal PWMOUT for the purpose of synchronization with other circuits. Furthermore, the LED modules 110a, 110b, 110c may use identical LEDs or different LEDs. For example, the LED modules 110a, 110b, 110c may be a red light LED module, a green light LED module, and a blue light LED module, respectively. If the three LED modules 110a, 110b, 110c are identical, the first preset level Vref1 received by the current adjusting units 134a, 134b, 134c can be the same, while in case of different LED modules, the first preset levels Vref1 corresponding to the three current adjusting units 134a, 134b, 134c may be different.

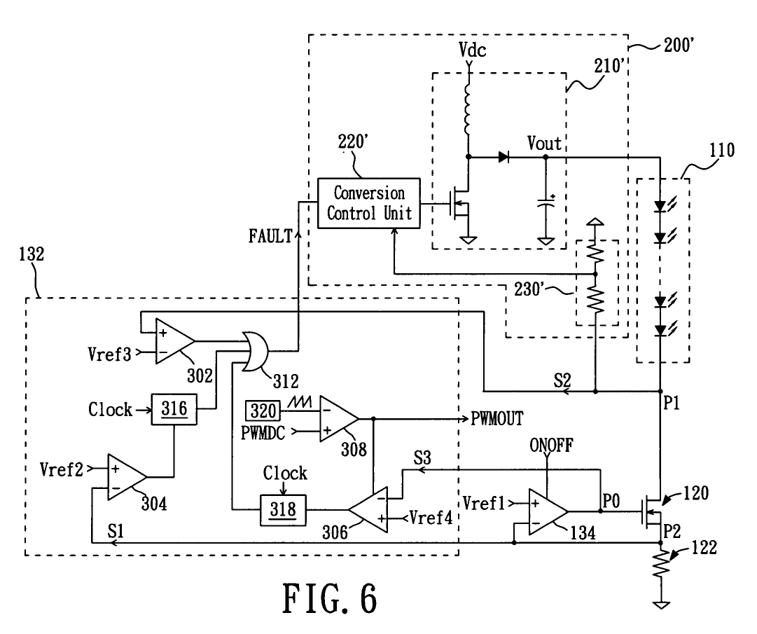

Refer now to FIG. 6, a circuit diagram of an LED driving circuit of another embodiment according to the present invention is shown. Compared with the aforementioned embodiments, the conversion circuit 200′ in the LED driving circuit of FIG. 6 is a DC-to-DC step-up conversion circuit with step-up ratio (output voltage/input voltage) depending on the duty cycle of the control signal of a PWM controller, rather than on the coil ratio as in the case of a transformer. The conversion circuit 200′ in FIG. 6 comprises a converting unit 210′, a conversion control unit (i.e. the PWM controller) 220′, and a voltage detection unit 230′. The converting unit 210′ has an inductor, a rectifying unit, a capacitor, and a switch. The inductor is coupled to a DC input power source Vdc. The switch is coupled to the inductor and is switching between conducting state and off state based on the control signal generated by the conversion control unit 220′. One end of the rectifying unit is coupled to the coupling point between the inductor and the switch, and the other end is coupled to the LED module 110. The capacitor is coupled to the coupling point between the rectifying unit and the LED module 110 in order to provide the DC output signal Vout. The voltage detection unit 230′ is coupled to one of the two ends of the LED module 110, and generates a voltage detection signal based on the voltage level of the coupled end of the LED module 110. The conversion control unit 220′ generates the control signal based on the voltage detection signal to have the voltage level at the end of the LED module 110 detected by the voltage detection unit 230′ stabilized around a preset voltage value. As illustrated in FIG. 6, the voltage detection unit 230′ is coupled to the negative end of the LED module 110 which is also the first I/O pin P1 of the current control unit 120. Thereby, the voltage level on the first I/O pin P1 can be stabilized at a preset voltage value to ensure conversion efficiency of the LED driving circuit.

The illustrations set out supra discuss merely the detailed descriptions and drawings of the preferred embodiments according to the present invention, rather than for restricting the present invention thereto. The scope of the present invention should be delineated by the subsequent claims, and all embodiments conforming to the spirit of the present invention as well as analogous variations thereof are deemed to be encompassed by the scope of the present invention. All changes or modifications that those skilled in the art can conveniently think of in the field of the present invention are deemed to be embraced within the scope defined by the following claims.

What is claimed is:

1. A Light Emitting Diode (LED) driving circuit, comprising:
a conversion circuit, coupled to an input power source, for converting an input from the input power source into a direct current (DC) output signal to drive an LED module;
at least one current control unit, each of the current control units having a control pin, a first input/output (I/O) pin, and a second I/O pin, and the first I/O pin being coupled to the LED module;
at least one current detection unit, each of the current detection units being coupled to the second I/O pin of the respective current control unit to generate at least one detection signal; and
a driving control unit, coupled to the control pin and the first I/O pin of the current control unit as well as the current detection unit, adjusting voltage level of the control pin of the current control unit based on the detection signal from the current detection unit to stabilize current flowing through the LED module around a preset current value;
wherein, in case voltage level of one of the first I/O pins being higher than a first preset level, the driving control unit cuts off the respective current control unit.

2. The LED driving circuit according to claim 1, wherein the conversion circuit comprises:
a transformer, having a primary side and a secondary side, the primary side coupled to the input power source, and the secondary side generating the DC output signal through a rectifying unit;
a switch set, coupled to the primary side of the transformer, and switched between conducting state and off state based on a control signal;
an output capacitor, coupled to the secondary side of the transformer, for filtering out noise in the DC output signal;
a voltage detection unit, coupled to the secondary side of the transformer, for generating a voltage detection signal based on the DC output signal; and
a primary side control unit, generating the control signal based on the voltage detection signal to have the DC output signal stabilized around a preset voltage value.

3. The LED driving circuit according to claim 1, wherein the conversion circuit comprises:
an inductor, coupled to the input power source;
a switch, coupled to the inductor, switched between conducting state and off state based on a control signal;
a rectifying unit, having one end coupled to a coupling point between the inductor and the switch and the other end coupled to the LED module;
an output capacitor, coupled to a coupling point between the rectifying unit and the LED module for providing the DC output signal;
a voltage detection unit, coupled to one end of the LED module for detecting voltage level at the end to generate a voltage detection signal; and
a conversion control unit, generating the control signal based on the voltage detection signal to have voltage level at the end detected by the voltage detection unit stabilized around a preset voltage value.

4. The LED driving circuit according to claim 1, wherein the current control unit comprises:
a current mirror unit, having a plurality of semiconductor switches, each semiconductor switch having a control end, a first I/O end, and a second I/O end, wherein the control end is connected to the control pin, the first I/O end is coupled to the LED module, and the second I/O end is coupled to the corresponding current detection unit; and
a selection unit, coupled to the first I/O ends of the semiconductor switches, selectively output a level signal from one of the first I/O ends to the driving control unit.

5. The LED driving circuit according to claim 1, wherein the driving control unit receives an on/off signal, and is utilized to cut off the at least one current control unit based on the on/off signal.

6. The LED driving circuit according to claim 5, wherein the driving control unit detects the at least one control pin, and as one of the detected control pins having voltage level lower than a second preset level, the driving control unit cuts off the respective current control unit.

7. The LED driving circuit according to claim 5, wherein the driving control unit detects the at least one second I/O pin, and as voltage level of one of the detected second I/O pins lower than a third preset level over a preset period of time, the driving control unit cuts off the respective current control unit.

8. The LED driving circuit according to claim 1, wherein the driving control unit receives a DC dimming signal and outputs a pulse-width-modulation (PWM) signal based on the DC dimming signal.

9. A LED driving circuit, comprising:
a conversion circuit, coupled to an input power source, for converting an input from the input power source into a DC output signal to drive an LED module;
at least one current control unit, each of the current control units having a control pin, a first I/O pin, and a second I/O pin, and the first I/O pin being coupled to the LED module;
at least one current detection unit, each of the current detection units being coupled to the second I/O pin of the respective current control unit to generate at least one detection signal; and
a driving control unit, which is coupled to the control pin and the first I/O pin of the current control unit as well as to the current detection unit, adjusting voltage level of the control pin of the current control unit based on the at least one detection signal from the at least one current detection unit to stabilize current flowing through the LED module around a preset current value,
wherein the driving control unit generates a fault signal as voltage level of one of the first I/O pins higher than a first preset level.

10. The LED driving circuit according to claim 9, wherein the conversion circuit comprises:
a transformer, having a primary side and a secondary side, the primary side coupled to the input power source, and the secondary side generating the DC output signal through a rectifying unit;
a switch set, coupled to the primary side of the transformer, and switched between conducting state and off state based on a control signal;
an output capacitor, coupled to the secondary side of the transformer, for filtering out noise in the DC output signal;
a voltage detection unit, coupled to the secondary side of the transformer, for generating a voltage detection signal based on the DC output signal; and
a primary side control unit, generating the control signal based on the voltage detection signal to have the DC output signal stabilized around a preset voltage value.

11. The LED driving circuit according to claim 9, wherein the conversion circuit comprises:
an inductor, coupled to the input power source;
a switch, coupled to the inductor, switched between conducting state and off state based on a control signal;
a rectifying unit, having one end coupled to a coupling point between the inductor and the switch and the other end coupled to the LED module;
an output capacitor, coupled to a coupling point between the rectifying unit and the LED module for providing the DC output signal;
a voltage detection unit, coupled to one end of the LED module for detecting voltage level at the end to generate a voltage detection signal; and
a conversion control unit, generating the control signal based on the voltage detection signal to have voltage level at the end detected by the voltage detection unit stabilized around a preset voltage value.

12. The LED driving circuit according to claim 9, wherein the current control unit comprises:
a current mirror unit, having a plurality of semiconductor switches, each semiconductor switch having a control end, a first I/O end, and a second I/O end, wherein the control end is connected to the control pin, the first I/O end is coupled to the LED module, and the second I/O end is coupled to the corresponding current detection unit; and
a selection unit, coupled to the first I/O ends of the semiconductor switches, selectively output a level signal from one of the first I/O ends to the driving control unit.

13. The LED driving circuit according to claim 9, wherein the driving control unit receives an on/off signal, and is utilized to cut off the at least one current control units based on the on/off signal.

14. The LED driving circuit according to claim 13, wherein the driving control unit detects the at least one control pins, and as one of the detected control pins having voltage level lower than a second preset level, the driving control unit cuts off the respective current control unit.

15. The LED driving circuit according to claim 13, wherein the driving control unit detects the at least one second I/O pins, and as voltage level of one of the detected second I/O pins lower than a third preset level over a preset period of time, the driving control unit cuts off the respective current control unit.

16. The LED driving circuit according to claim 9, wherein the driving control unit receives a DC dimming signal and outputs a PWM signal based on the DC dimming signal.

17. A LED driving circuit controller, utilized to control an LED driving circuit for driving at least a first LED module, comprising:
a first current adjusting unit, generating a first current adjusting signal according to a first current detection signal indicating magnitude of current flowing through a first LED module to control a first power switch connected in series to the first LED module so as to have voltage level of the first current detection signal stabilized around a first preset voltage value; and
a signal processing unit, detecting a voltage signal from a first coupling point between the first power switch and the first LED module, receiving the first current detection signal, and generating a fault signal as either voltage level of the first current detection signal lower than a first preset level over a preset period of time or voltage level of the voltage signal from the first coupling point higher than a second preset level.

18. The LED driving circuit controller according to claim 17, wherein the signal processing unit further receives an on/off signal and controls the first current adjusting signal to cut off the first power switch when the on/off signal is at a level indicating off state.

19. The LED driving circuit controller according to claim 18, wherein the signal processing unit further detects voltage level of the first current adjusting signal as the on/off signal is not at the level indicating off state, and generates the fault signal when voltage level of the first current adjusting signal is lower than a third preset level.

20. The LED driving circuit controller according to claim 17, wherein the signal processing unit receives a DC dimming signal and outputs a PWM signal based on the DC dimming signal.

21. The LED driving circuit controller according to claim 20, wherein the signal processing unit controls the first current adjusting signal based on the PWM signal to turn off the first power switch periodically to dim the first LED module.

22. The LED driving circuit controller according to claim 17, further comprising a second current adjusting unit, generating a second current adjusting signal based on a second current detection signal indicating magnitude of current flowing through a second LED module driven by the LED driving circuit to control a second power switch connected in series with the second LED module so as to have voltage level of the second current detection signal stabilized around a second preset voltage value.

23. The LED driving circuit controller according to claim 22, wherein the signal processing unit further detects a voltage signal from a second coupling point between the second power switch and the second LED module and receives the second current detection signal, and generates the fault signal as either voltage level of the second current detection signal lower than the first preset level over the preset period of time or voltage level of the voltage signal from the second coupling point higher than the second preset level.

24. The LED driving circuit controller according to claim 22, wherein the first preset voltage value is substantially equal to the second preset voltage value.

25. The LED driving circuit controller according to claim 22, wherein the signal processing unit further receives an on/off signal and controls the first current adjusting signal and the second current adjusting signal to turn off the first power switch and the second power switch respectively when the on/off signal is at the turn-off level.

26. The LED driving circuit controller according to claim 25, wherein there is a default time interval between turn-off time of the first power switch and that of the second power switch.

27. The LED driving circuit controller according to claim 25, wherein the signal processing unit further detects level of the first current adjusting signal and that of the second current adjusting signal as the on/off signal is not at the turn-off level, and generates the fault signal as voltage level of the first current adjusting signal or the second current adjusting signal is lower than a third preset level.

28. The LED driving circuit controller according to claim 21, wherein the signal processing unit controls the first current adjusting signal and the second current adjusting signal based on the PWM signal to turn off the first power switch and the second power switch periodically to dim the first LED module and the second LED module respectively.

29. The LED driving circuit controller according to claim 28, wherein there is a default time interval between turn-off time of the first power switch and that of the second power switch.
